(19) United States
(12) Patent Application Publication
(10) Pub. No.: US 2009/0316981 A1
(43) Pub. Date: Dec. 24, 2009

(54) Method and device for inspecting a disk-shaped object

(75) Inventors: Hans-Juergen Brueck, Munich (DE); Gerd Scheuring, Munich (DE); Andreas Machura, Wetzlar (DE); Ralf Langenbach, Freudenberg (DE)

Correspondence Address: Davidson, Davidson & Kappel, LLC, 485 7th Avenue, 14th Floor, New York, NY, 10018, US

(73) Assignee: VISTEC Semiconductor Systems GmbH, Weilburg (DE)

(21) Appl. No.: 12/456,184

(22) Filed: Jun. 12, 2009

(30) Foreign Application Priority Data
Jun. 19, 2008 (DE) DE 102008028869.1

(51) Int. Cl. G06K 9/00

(52) U.S. Cl. 382/149

(57) ABSTRACT

In order to improve the detectability of defects in structures incorporated beneath the surface of a wafer, it is suggested to acquire an IR subimage of the illuminated wafer with an IR image acquisition device and a VIS subimage with a VIS image acquisition device. The acquisition is performed simultaneously and is controlled such that the same area of the wafer is imaged sharply by both image acquisition devices. An image processor is used to determine whether a detected defect is attributable to a defect on the surface or to a defect of the structures located beneath the surface.

This claims the benefit of German Patent Application No. 10 2008 028 869.1, filed on Jun. 19, 2008 and hereby incorporated by reference herein.

The present invention relates to a method for inspecting a wafer. Additionally, the present invention relates to a wafer inspecting means

### BACKGROUND

For the industrial production of chips for the semiconductor industry, integrated circuits are produced on disk-shaped carriers in several consecutive steps. As part of this production process, each disk-shaped carrier, hereinafter also referred to as wafer, is sequentially processed so that a plurality of identical, repetitive structural elements, the so-called DIEs, are generated on the wafer. As integration density increases, the requirements regarding the quality of the structures formed on the wafers are stepped up as well. In order to be able to check the quality of the formed structures and detect potential defects, the requirements regarding quality, precision and reproducibility of the wafer-handling elements and process steps are correspondingly high. This means that reliable and early detection of defects in each structure must be achieved for the production of a wafer including a plurality of process steps and a plurality of layers to be applied, such as photoresist and the like.

Optical devices are particularly suitable for inspecting the surface of wafers. For example, the surface may, as known from EP 455 857, be inspected by evaluating beams reflected from the surface of the wafer.

There are also known optical devices allowing the detection of a large variety of structures on the surface of a wafer or a semiconductor substrate by means of image recognition. In this case, the wafer is usually illuminated in the bright field and scanned by a camera, such as a matrix or line camera.

U.S. Pat. No. 6,587,193 further discloses an inspection of the surface of a wafer, wherein an illumination is chosen that scans the wafer in the form of a line. The illumination line is arranged across the surface of the wafer such that a two-dimensional image may be generated.

Furthermore US 2008/026232 A1 discloses a method for examining a monocrystalline semiconductor disk. For finding and/or inspecting the defects, at least one side of the semiconductor disk is irradiated by a laser. The laser radiation emits an IR wavelength.

For the examination of microstructured samples, for example of a wafer, there are currently mostly used examining means and methods operating in the visual or UV reflected or incident light mode. In order to expand the field of application of these means, i.e. particularly to image structural details that are not visible in VIS or UV due to a lack of transparency of coatings or intermediate materials, DE 10 2004 029 212 B4 suggests a method and a device for inspecting wafers. They use VIS light for the incident light and at the same time generate an IR transmitted light illumination affording, for example, a significantly improved contrast of the IR image. In that way, the sample may simultaneously be imaged in IR incident and/or transmitted light and in VIS incident light.

Since silicon is transparent in infrared, particles, such as dust particles, located on the surface of the sample cause a shadowing effect and thus interfere with the evaluation of the IR measurement. If the surface particles and the structures to be inspected are located within the depth of field of the used instrument, it is hard or even impossible to determine whether the defects are in the structure applied to the wafer or only simulated by such particles. In the infrared image, both appear sharp at the same time.

### SUMMARY OF THE INVENTION

It is an object of the present invention to provide a method for improving the detection of defects in structures of a wafer through a layer of silicon.

The present invention provides a method for inspecting a wafer comprising the steps of:
illuminating a subarea of the wafer with an illumination means for with IR light and VIS light;
simultaneously acquiring an IR subimage with an IR image acquisition means and a VIS subimage with a VIS image acquisition means, wherein the acquisition of the subimages is controlled such that an identical image field of the wafer is imaged by the IR image acquisition means and the VIS image acquisition means,
determining a result by analyzing the IR subimage and the VIS subimage as to whether there is a defect on the surface of the wafer, particularly whether there is a particle located on the surface,
examining a structure located beneath the surface of the wafer in the examined IR subarea if it has been determined that there is no defect on the surface of the wafer.

It is a further object of the present invention to provide a device for improving the detection of defects in structures of a wafer through a layer of silicon.

The present invention further provides a wafer inspecting means comprising: an IR image acquisition means sensitive to light in the infrared wavelength range; a VIS image acquisition means sensitive to light in the visible wavelength range; a control means; an image processor and wherein the IR image acquisition means and the VIS image acquisition means are designed and arranged such that the wafer is scanned simultaneously in subimages to aquire an IR subimage and a VIS subimage.

Accordingly, the present invention provides a method for inspecting a wafer. For this purpose, there are provided an IR image acquisition means sensitive to light in the infrared wavelength range (IR) and a VIS image acquisition means sensitive to light in the visible wavelength range (VIS). The wafer is simultaneously scanned in subimages by the IR image acquisition means and the VIS image acquisition means, wherein an IR subimage and a VIS subimage are acquired. With the help of a control means, the IR subimage and the VIS subimage are coordinated such that they image the same image field of the surface of the wafer. An image processor determines if a defect of the surface of the wafer, particularly a dust particle, is detectable. If there is no such defect on the surface, an examination may be conducted whether a structure located beneath the surface of the wafer is defective in the examined IR subarea.

In one embodiment of the invention, the wafer is moved by a suitable sample holder, while the IR image acquisition means and the VIS image acquisition means acquire the subimages, wherein the whole wafer is scanned. Preferably, an optical and/or mechanical adjusting element is set such that the IR subimage and the VIS subimage are sharp at the same time, and that the fields of view of both cameras are identical. Furthermore, the adjustment is performed such that the fields of view of the IR image acquisition means and the VIS image acquisition means are identical.

In a further embodiment of the invention, a marking may be stored for the examined subarea in an event presentation of the wafer if a defect is detected on the surface of the wafer, wherein there are particularly stored the coordinates of the subarea and a marker. This allows another inspection of the subarea after the marking has been stored.

This method allows examining the defects or structures located beneath a silicon layer. At the same time, it allows determining whether a detected defect is attributable to an unwanted particle on the surface of the object or to a defect located beneath the surface. Thus it allows an unambiguous determination whether there is a defect that is attributable to a manufacturing fault of the wafer.

The IR image acquisition means and the VIS image acquisition means are preferably implemented as cameras that acquire the subimages of the same location at the same time.

Furthermore, the control means preferably includes software designed such that the image fields of the two cameras are identical.

The wafer inspecting means thus can comprise an IR image acquisition means sensitive to light in the infrared wavelength range. There is further provided a VIS image acquisition means sensitive to light in the visible wavelength range. There are further provided a control means and an image processor. With the help of the IR and VIS image acquisition means, the surface of the wafer may simultaneously be scanned in subimages, wherein there may be acquired a first and a second subimage. The control means is designed such that it allows coordinating the first and the second subimage so that they image the same image field of the surface of the wafer. The image processor is designed such that it allows determining whether a detected defect is attributable to a defect on the surface or to a defect of the “hidden” structures located beneath the surface.

The control means is preferably designed such that it allows coordinating the IR subimage and the VIS subimage so that they image the same image field of the wafer.

The image processor may be designed such that it allows determining if a detected defect is attributable to a defect on the surface, particularly to a particle located on the surface.

In a further embodiment of the invention, there is provided an optical and/or a mechanical adjusting element for adjusting the field of view and/or the definition of the VIS image acquisition means and the IR image acquisition.

### BRIEF DESCRIPTION OF THE DRAWINGS

Further advantages and advantageous embodiments of the invention are discussed in the following drawings and their associated parts of the description, wherein:

FIG. 1 shows a schematic of a basically feasible embodiment of the inventive device; and

FIG. 2 schematically shows the steps of the inventive method.

### DETAILED DESCRIPTION

Throughout the drawings, identical reference numerals refer to elements or functional groups that are identical or have essentially the same function.

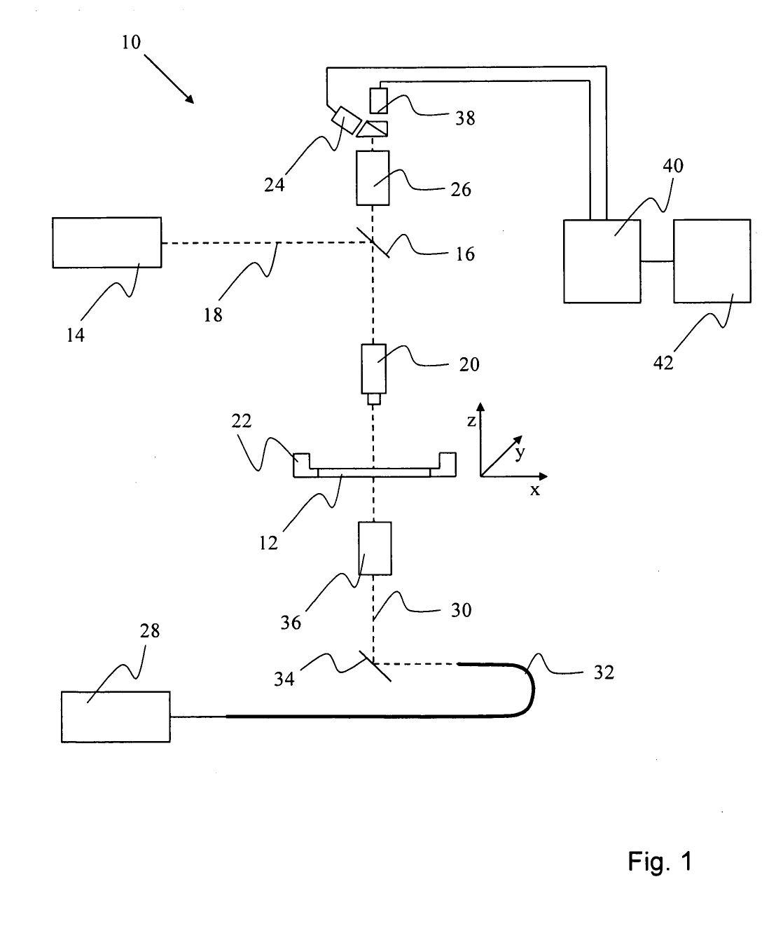

FIG. 1 schematically shows, by way of example, the inventive structure of a wafer inspecting means or device 10, for example a microscope for observing a wafer 12 on which there may be provided microstructures. The wafer inspecting means 10 comprises an incident light illumination 14 from which light 18 may directly or indirectly be launched in onto the wafer 12. The incident light illumination 14 is designed so that it may emit light of a desired wavelength or of a desired wavelength range of the visible (VIS) spectral range. Via a beam-splitting mirror 16, the incident light beam 18 may be directed to the wafer 12, which may be fixed by a holder 22. The light of the incident light source 14 may also be launched in directly, for example with the help of a light guide.

The light reflected from the wafer 12 may be captured as a first subimage by an objective 12, for example an objective attached to an objective turret. Via a tube lens 26, if necessary, the thus captured first subimage is supplied to a VIS image acquisition means 24.

At the underside of the wafer 12, there is provided a transmitted light illumination 28, with the help of which the wafer 12 may simultaneously be illuminated in transmitted light. The transmitted light illumination 28 is designed so that it may emit light of an IR spectral range for the transmitted light illumination of the wafer. An optical fiber 32, particularly an optical fiber bundle, is preferably used for launching the IR transmitted light 30 in onto the wafer 12. Via a beam splitting mirror 34 and a condenser 36, the IR transmitted light 30 is then directed to the wafer 12. The image is supplied to an IR image acquisition means 38 as a second subimage.

The described arrangements may include further optical components, if necessary.

According to the invention, the whole wafer 12 is scanned, for example in a meandering way, wherein the images are simultaneously acquired in subimages by the IR image acquisition means 38 and the VIS image acquisition means 24. This may, for example, be ensured by providing a suitable optical and/or a suitable mechanical adjusting element. In that way, an IR subimage and a VIS subimage are acquired. With the help of a control means 40, the first and the second subimage are coordinated such that they image the same image field of the wafer 12. Focusing of the wafer 12 may be done manually or automatically via an auto-focus system. This ensures that subimages are sharp at the same time and that the fields of view of both image acquisition means are identical.

An image processor 42 determines whether a detected defect is attributable to a defect on the surface or to a defect of the “hidden” structures located beneath the surface. The defects of the structure and the surface particles may be observed with the help of the IR image acquisition means 38, while the VIS image acquisition means 24 only allows observing the surface of particles. In the image processor 42, the IR subimage and the VIS subimage are analyzed. If a particle is visible in the VIS subimage, this location is marked in the event presentation of the wafer 12 so that it may later be inspected again, if necessary.

If no particle is visible in the VIS subimage, this location of the wafer 12 is examined for defects/faults.

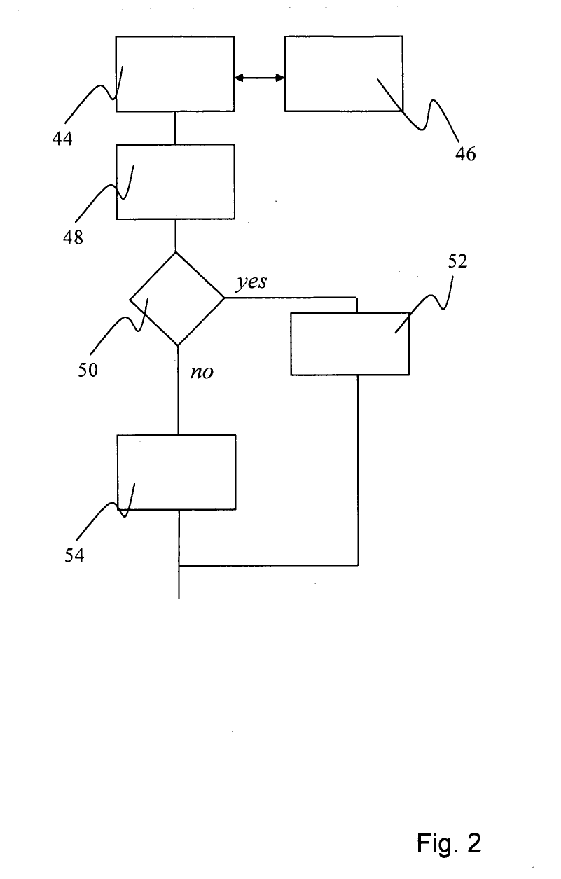

FIG. 2 schematically shows the steps of the inventive method. The wafer 12 is illuminated with light of the VIS spectral range and the IR spectral range. In the acquisition step 44, the wafer 12 is moved, particularly in a meandering way, wherein the wafer 12 is simultaneously imaged in a number of subimages by an IR image acquisition means 38 and a VIS image acquisition means 24. Correspondingly, an IR subimage and a VIS subimage are acquired for each spectral range and each subarea. During the control step 46, which is performed at the same time, a control means is used to coordinate the IR subimage and the VIS subimage so that they image the same image field of the wafer 12 sharply at the same time. Then the IR subimage and the VIS subimage are supplied to an image processor 28 in step 48. With the help of the image processor 28, the two subimages are compared, wherein the comparing step 50 serves to check whether a particle is detectable in the VIS subimage. If yes, this subarea of the wafer 12 may be marked in a so-called event presentation of the wafer 12 in step 52 to permit another, later inspection of this location, i.e. this subarea. For this purpose, the coordinates of the location may be stored, for example, and provided with a marker, such as “particle found”.

If no particle is found in the VIS subimage, there may be an examination in step 54 whether the subarea has defects or faults in its structure located beneath the surface of the wafer 12.

In principle, the described examination for defects may be performed while the wafer 12 is scanned. However, it is also possible to first scan the wafer 12 completely, to store the acquired subimages and to perform the examination for defects subsequently by comparing the subimages. In both cases, the examination whether there is a defect is conducted by analyzing the acquired subimages.

The invention has been described with reference to particular embodiments. However, someone skilled in the art will appreciate that modifications and changes may be made to the invention without departing from the scope of the following claims.

What is claimed is:

1. A method for inspecting a wafer comprising the steps of:
illuminating a subarea of the wafer with an illumination means for with IR light and VIS light;
simultaneously acquiring an IR subimage with an IR image acquisition device and a VIS subimage with a VIS image acquisition device, wherein the acquisition of the subimages is controlled such that an identical image field of the wafer is imaged by the IR image acquisition device and the VIS image acquisition device,
determining a result by analyzing the IR subimage and the VIS subimage as to whether there is a defect on the surface of the wafer, and
examining a structure located beneath the surface of the wafer in the examined IR subarea if it has been determined that there is no defect on the surface of the wafer.

2. The method of claim 1, wherein the defect is a particle located on the surface.

3. The method of claim 1, wherein the wafer is moved by a suitable sample holder, while the IR image acquisition device and the VIS image acquisition device acquire the subimages, wherein the whole wafer is scanned.

4. The method of claim 1 wherein an optical and/or mechanical adjusting element is set such that the IR subimage and the VIS subimage are in focus at the same time, and that fields of view of both cameras are identical.

5. The method of claim 4, wherein the fields of view of the IR image acquisition device and the VIS image acquisition device are identical.

6. The method of claim 1, wherein a marking is stored for the subarea in an event presentation of the wafer if it is determined that a defect is located on the surface of the wafer.

7. The method of claim 6, wherein the coordinates of the subarea and a marker are stored as a marking.

8. The method of claim 7, wherein another inspection of the subarea is performed after the marking has been stored.

9. A wafer inspecting device comprising: an IR image acquisition device sensitive to light in the infrared wavelength range; a VIS image acquisition device sensitive to light in the visible wavelength range; a controller; an image processor and wherein the IR image acquisition device and the VIS image acquisition device are designed and arranged such that the wafer is scanned simultaneously in subimages to aquire an IR subimage and a VIS subimage.

10. The wafer inspecting device of claim 9, wherein the controller is designed such that it allows coordinating the IR subimage and the VIS subimage so that they image the same image field of the wafer.

11. The wafer inspecting device of claim 9, wherein the image processor is designed such that it allows determining if a detected defect is attributable to a defect on the surface.

12. The wafer inspecting device of claim 11 wherein the defect is a particle located on the surface.

13. The wafer inspecting device of claim 9, wherein an optical and/or a mechanical adjusting element is provided for adjusting the field of view and/or the definition of the VIS image acquisition device and the IR image acquisition device.
